(19) United States
(12) Patent Application Publication
(10) Pub. No.: US 2005/0283312 A1
(43) Pub. Date: Dec. 22, 2005

(54) Method and device for improving GPS-based positioning of vehicles on roads

(75) Inventor: Vikas Taliwal, Palo Alto, CA (US)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/869,188

(22) Filed: Jun. 16, 2004

(51) Int. Cl. G01C 21/26

(52) U.S. Cl. 701/214; 701/213; 342/358

(57) ABSTRACT

A method for estimating an error in GPS signals used by a vehicle estimates an error in the GPS signals received by the vehicle as a function of a difference in a geometry of the GPS signals related to a curved section of the road and a geometry of the curved section of the road. A device and vehicle for utilizing the method are also provided.

### BACKGROUND

The present invention relates to a method and device for improving positioning of vehicles using a global satellite positioning device and road information.

GPS devices for vehicles can provide position and heading, i.e. direction, information. Typical non-differential GPS devices can have errors in longitude and latitude measurements of as large as 10 m to 15 m.

Digital road maps, also called street maps, provide all types of digital information on roads, such as their physical coordinates and whether the roads are one-way or not. The geometry of a road, for example whether a section of the road is straight or curved, at any location thus may be known from the digital road map information.

U.S. Pat. Nos. 5,058,023 and 6,249,246, German Patent Application No. 101 29 444, and European Patent Application Nos. 0 523 860 and 0 738 877 describe methods and/or devices for improving the accuracy of vehicle positioning.

### SUMMARY OF THE INVENTION

An object of the present invention is to improve the accuracy of vehicle positioning using a GPS device and road information.

The present invention provide a method for estimating an error in GPS signals used by a vehicle comprising the step of: estimating an error in the GPS signals received by the vehicle as a function of a difference in a geometry of the GPS signals related to a curved section of the road and a geometry of the curved section of the road.

On a curved section of the road the GPS signals related to the curved section, which define a curved GPS trace, generally will present a different geometry than the geometry of the curved section of the road at the GPS trace points. The geometry of the curved section of the road may be determined for example by position information from a digital road map related to the curved section. Alternatively, the digital road map may store specific curve information, such as a radius of curvature of the curve at a centerline of the road. The actual position information on the curved section defines a map trace for the curved section.

The geometry of the curved section of the road is preferably determined at the location of the GPS signals.

The method may further include correcting the GPS signals as a function of the error to provide corrected GPS signals. Since GPS translational errors slowly vary in time, the corrected GPS signals using the errors determined in the curved section advantageously may be used for a straight section following the curved section. The correction can be applied for tens of minutes, and can be re-estimated when the vehicle passes another curved section.

In the curve, a translational error in the GPS trace along the road results in a mismatch in headings, whereas an error transverse to the road results in a mismatch in curvature. The amounts of the translational and transverse errors are detectable in the curve due to the differing geometry of the actual road curve and the GPS trace. Thus the GPS translation and transverse errors should be determinable even with random GPS noise errors, and any errors related to the map trace or to the actual trace of the vehicle with respect to the map trace.

Preferably, the GPS error when the vehicle is traveling clockwise is estimated by the following equations:
Δx=Rg cos hg−Rr cos hr; and
Δy=Rg sin hg−Rr sin hr;

where the vehicle heading at a GPS point P is hg, the road heading at P is hr, the radius of curvature of the vehicle path, i.e. the GPS points, at P is Rg and the radius of curvature of road at P is Rr.

When the vehicle is traveling counterclockwise, the negative of each of the above equations is used.

The present invention may also comprise the step of determining if the vehicle is traveling in a clockwise or counterclockwise direction, for example from the direction of progression and arc of the GPS trace.

The error amount preferably is estimated for each point on the trace over the curve, and an average value is calculated for Δx and Δy, which are used as the approximate amounts for the GPS position error.

The error amounts can then be subtracted from future GPS signals to provide corrected GPS signals.

The present invention also provides a device for measuring GPS signal errors for a vehicle, the device comprising a GPS device, a processor for determining a curved section of a road, and a memory for storing a digital road map, the processor estimating an error in the GPS signals received by the vehicle as a function of a difference in a geometry of the GPS signals related to the curved section of the road and a geometry of the curved section of the road.

The GPS device advantageously may be a non-differential GPS device.

The memory may be a temporary memory which receives the digital road information wirelessly, or may be any other type of memory device, such as an on-board CD-ROM.

### BRIEF SUMMARY OF THE DRAWINGS

To illustrate the present invention, FIG. 1 shows schematically a vehicle according to the present invention in a curve;

FIG. 2 shows hypothetical tracings of the vehicle through a full circular section of the road with a GPS device having a longitudinal and latitudinal error; and

FIG. 3 shows a hypothetical tracing through a circular route with a GPS device having a purely longitudinal error.

### DETAILED DESCRIPTION OF AN EMBODIMENT

FIG. 1 shows a vehicle 10 having a processor 20 connected to a GPS receiver 30. A memory 40 provides digital road map information to the processor 20. The digital road map information includes information on single lane road 100, which has an outer boundary 110 and inner boundary 140. Road 100 may be for example a highway, and road map information can identify the road 100, for example providing detailed position information for points along a centerline 130 of road 100. The curvature, and thus the radius of curvature, for the curved section of the road 100 thus can be determined from the road map information. The road heading for the road 100 along the points of the curve of the road thus can also be determined. Alternately, information, such as the radius of curvature, could be provided with the road map information.

Due to error in the information provided by GPS device 30, the GPS device may locate the vehicle at a point P. At the point P on the curve as determined by the GPS signal, road 100 has a road heading hr and a radius of curvature Rr which may be determined or estimated from the digital road map information, for example by estimating the distance of P from the centerline 130. If the digital map provides further information, such as lane information or boundary 140, 110 information, this information can also be used to improve and/or estimate the road heading hr and radius of curvature Rr at point P. Digital maps with radius of curvature information on curves could also be created and used.

The vehicle has a vehicle heading hg and a travel radius of curvature Rg which may be estimated from the GPS heading and trace curvature. The headings hr and hg may be expressed in terms of the clockwise angle of the road with respect to geographical north, for example. The vehicle heading hg may be taken from the GPS heading signal, or estimated from the GPS trace, and the radius of curvature Rg may be estimated from the GPS trace.

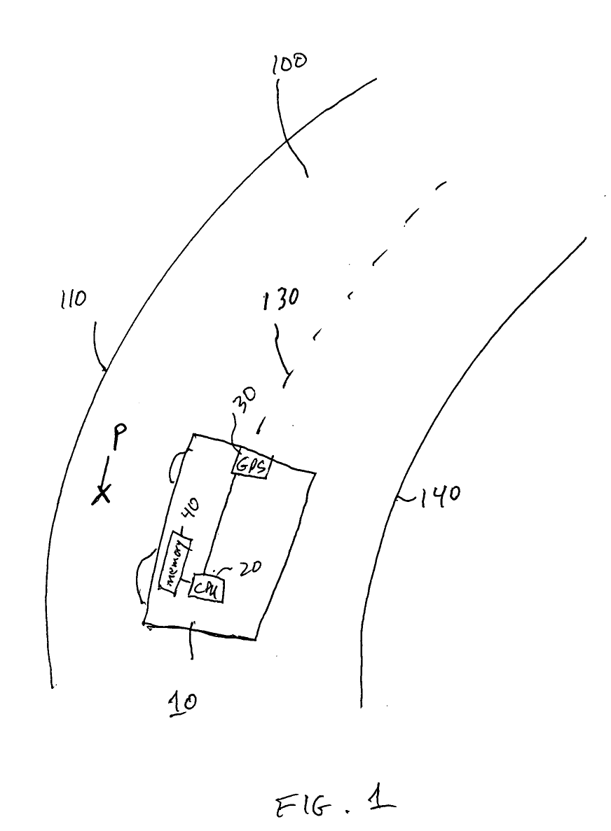

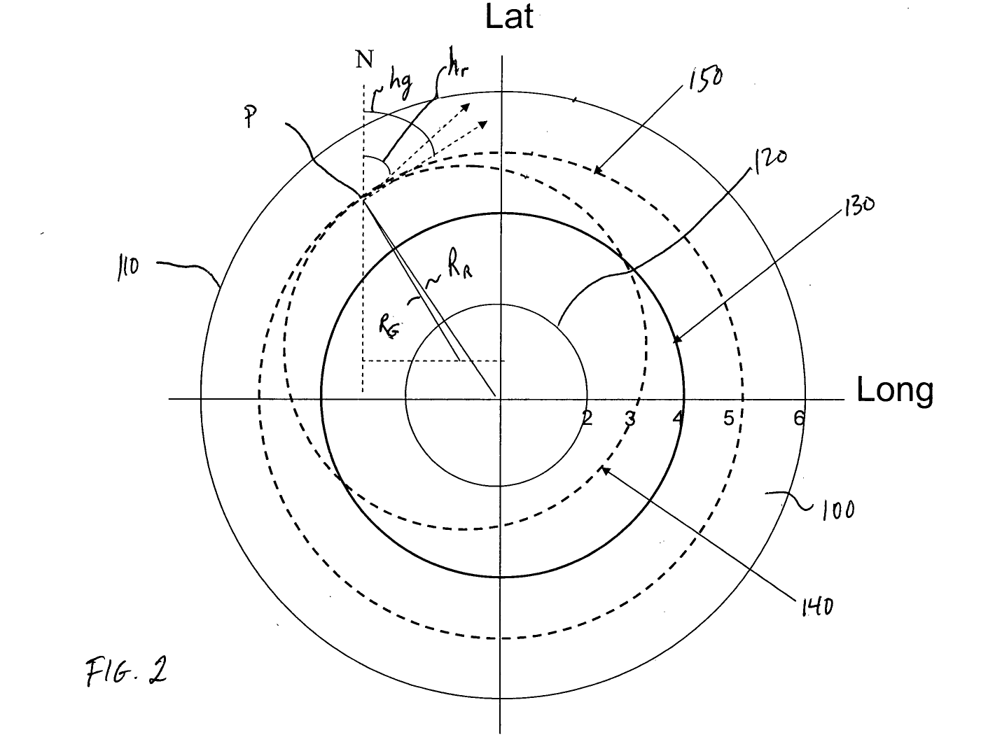

FIG. 2 illustrates the present invention using a simplified example where a vehicle is traveling in a full circle along a road 100 having an inner radius 120 of 2 units and an outer radius 110 of 6 units. The vehicle actually travels in a path 130, but the GPS receiver of the vehicle has a latitudinal and longitudinal error, so that a GPS trace 140 results. At a point P, the road has a radius of curvature Rr of 5 units as indicated by circle 150, while the GPS trace has a radius of curvature of 4 units.

A vehicle heading hg may be determined from GPS receiver 30. In the present invention, the GPS heading information may be used as the vehicle heading hg. The vehicle heading hg may also be determined using two or more GPS positional data points. The vehicle heading may be expressed as the clockwise angle from geographical north as is typically of GPS information.

As can be seen from FIG. 2, the GPS error may be estimated by the following equations when the vehicle is traveling clockwise:
Δx=Rg cos hg−Rr cos hr; and
Δy=Rg sin hg−Rr sin hr;

where Δx is the error in the longitudinal direction and Δy is the error in the latitudinal direction, the vehicle heading at a GPS point P is hg, the road heading at P is hr, the radius of curvature of the vehicle path, i.e. the GPS points, at P is Rg and the radius of curvature of road at P is Rr.

Each GPS trace point on the curve can be used and the average taken to determine the GPS error.

Note that if the vehicle were traveling counterclockwise, the headings hr and hg increase by 180 degrees each, so that the negative of the error in the clockwise direction results from the formulae. Thus the negative of the formulae is used when traveling counterclockwise.

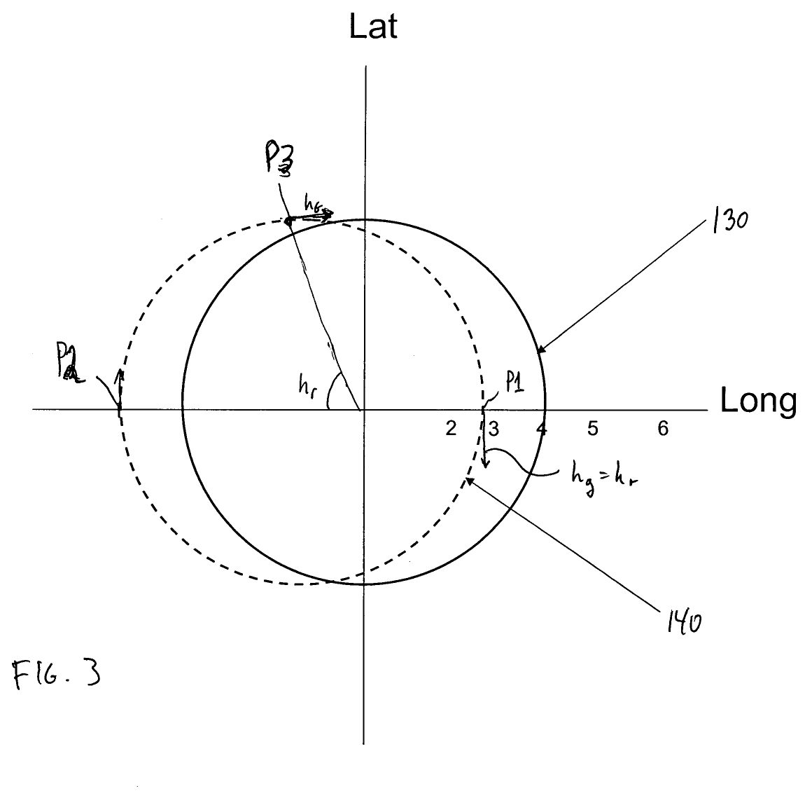

FIG. 3 shows an example where the clockwise GPS trace 140 is offset by one unit in the x, i.e. longitudinal, direction. At point P1 hg=hr=180 degrees, and Rr equals 3 and Rg equals 4. The error in the x direction is thus −4+3 or negative 1, and zero in the y direction. At point P2, hg=hr=0 and Rr=5 and Rg=4. The error in the x direction again is 4−5 or negative 1 and zero in the y direction. At a point P3, where hg=90 degrees and Rg is 4 units, hr=76.0 degrees and Rr=4.12 units. The equations yield an error in the x direction of negative 1, and an error in the y direction of zero, as elsewhere on the circle.

Thus for any section of the circle, an average of the error at all GPS points on the curve may be used. Since GPS translational error is relatively stable, the GPS points on a straight section may then be corrected using the information obtained on the curve. During a next curve section in the road, the error calculations may be performed again.

1. A method for estimating an error in GPS signals used by a vehicle comprising the step of:
estimating an error in the GPS signals received by the vehicle as a function of a difference in a geometry of the GPS signals related to a curved section of the road and a geometry of the curved section of the road.

2. The method as recited in claim 1 wherein the geometry of the curved section of the road is determined at the location of the GPS signals.

3. The method as recited in claim 1 further comprising correcting the GPS signals during a straight section of the road following the curved section of the road as a function of the error estimated on the curved section of the road.

4. The method as recited in claim 3 further comprising re-estimating the error in a further curved section following the straight section.

5. The method as recited in claim 1 wherein a magnitude of the error is estimated using the following equations: Δx=Rg cos hg−Rr cos hr; and Δy=Rg sin hg−Rr sin hr, where Rg is a radius of curvature of the GPS signals, Rr is a radius of curvature of the road at a location of the GPS signals, hg is a heading of the GPS signals, and hr is a road heading at a location of the GPS signals.

6. The method as recited in claim 1 further comprising determining if the vehicle is traveling in a clockwise or counterclockwise direction in the curved section.

7. The method as recited in claim 1 wherein the geometry of the GPS signals is a determined from at least three GPS signal points.

8. The method as recited in claim 1 wherein the geometry of the curved section of the road is determined from digital road map information.

9. A device for measuring GPS signal errors for a vehicle, the device comprising:
a GPS device;
a processor for determining a curved section of a road; and
a memory for storing a digital road map, the processor estimating an error in the GPS signals received by the vehicle as a function of a difference in a geometry of the GPS signals related to the curved section of the road and a geometry of the curved section of the road.

10. The device as recited in claim 9 wherein the GPS device is a non-differential GPS device.

11. A vehicle comprising:
a GPS device;
a processor for determining a curved section of a road; and
a memory for storing a digital road map, the processor estimating an error in the GPS signals received by the vehicle as a function of a difference in a geometry of the GPS signals related to the curved section of the road and a geometry of the curved section of the road.

12. A method for estimating an error in GPS signals used by a vehicle comprising the step of:
estimating an error in the GPS signals received by the vehicle as a function of a vehicle heading at a GPS signal point and a road heading at the GPS signal point in a curved section of a road.

13. The method as recited in claim 12 wherein the error is estimated as a function of a GPS radius of curvature and a road radius of curvature at the GPS signal point.

14. A method for estimating an error in GPS signals used by a vehicle comprising the step of:
estimating an error in the GPS signals received by the vehicle a function of a GPS radius of curvature and a road radius of curvature at a GPS signal point in a curved section of a road.
